(19) United States
(12) Patent Application Publication
(10) Pub. No.: US 2011/0311727 A1
(43) Pub. Date: Dec. 22, 2011

(54) WELDABLE PRE-PRIMED COATING COMPOSITION FOR AUTOMOTIVE OEM AND COATING METHOD THEREOF

(76) Inventors: CHOONG-YEOL KANG, Seoul (KR); Seung-Man Noh, Asan-si (KR); Joon-Hyun Nam, Cheonan-si (KR); Je-lk Moon, Yongin-si (KR); Hyun-Joong Kim, Seoul (KR)

(21) Appl. No.: 12/843,215

(22) Filed: Jul. 26, 2010

(30) Foreign Application Priority Data
Jun. 21, 2010 (KR) 10-2010-0058403

(51) Int. Cl. B05D 3/10; H01B 1/22

(52) U.S. Cl. 427/327; 252/503; 977/742

(57) ABSTRACT

The present invention relates to a weldable pre-primed coating composition, comprising binder resins, a crosslinker, an anti-corrosive pigment, conductive metal powder, carbon nanotubes, etc. The coating composition can be applied to a metal sheet before processing of the metal sheet to maximize the weldability, adhesion, corrosion resistance and processability of the metal sheet. Also, the coating composition can be applied to a metal sheet by a roll coating process to make it possible to eliminate not only an existing electrodeposition process which is carried out by a non-environmentally-friendly wet dipping process, but also an existing electrostatic spray primer coating process which is carried out by an electrostatic spray coating process in which a solvent is scattered, whereby the metal sheet coated with the coating composition has very excellent formability and weldability after its processing. Accordingly, the composition makes it possible to reduce the number of complex automotive coating processes, thereby greatly contributing an increase in productivity, a reduction in energy and an improvement in a work environment.

### CROSS-REFERENCE TO RELATED APPLICATIONS

This application claims the benefit of Korean Patent Application No. 10-2010-0058403, filed on Jun. 21, 2010 in the Korean Intellectual Property Office, which is incorporated herein by reference in its entirety.

### BACKGROUND OF THE INVENTION

(a) Field of the Invention

The present invention relates to a weldable pre-primed coating composition for automotive OEM, comprising binder resins, a crosslinker, an anti-corrosive pigment, conductive metal powder, carbon nanotubes, etc., and a coating method thereof, and more particularly, to a weldable pre-primed coating composition for automotive OEM, which can be applied to a metal sheet before processing of the metal sheet to maximize the weldability, adhesion, corrosion resistance and processability of the metal sheet and makes it possible to eliminate an existing electrodeposition coating process in an automotive painting process, thus reducing the number of coating facilities and maximizing productivity, and a coating method thereof.

(b) Background of the Related Art

In general, an automotive painting process includes electrodeposition coating, primer coating, top coating and the like, which are carried out after cutting, processing, welding and assembling of galvanized steel sheets, such as galvannealed (GA) steel sheets, hot-dipped galvanized (GI) steel sheets and electro-galvanized (EGI) steel sheets, to manufacture a car body, followed by pretreatment of the car body surface with phosphate. This painting process is the last process of automotive body production processes and is roughly divided into a degreasing process of removing various oils and dust from the steel sheet surface, a process of treating the steel sheet surface with phosphate to improve the corrosion resistance of the steel sheet surface and the adhesion of an electrodeposition coat to the steel sheet surface, and a process of painting the steel sheet surface. The painting process comprises an electrodeposition process of forming an electrodepostion coat as a base coat for improving corrosion resistance and adhesion to a steel sheet, a primer coating process for improving corrosion resistance and smoothness and improving the adhesion between the electrodeposition coat and a top coat, and a top coating process for forming a top coat providing the final appearance while exhibiting gloss, clarity and durability.

However, the painting process as described above is a large-scale process consisting of a series of very complex processes and is a non-environmentally-friendly, labor-intensive process which necessarily requires a large-scale paint shop, various equipment and labor for each process. This process has been pointed out as the slowest and most inefficient process in finished-vehicle production processes. In particular, the existing electrodeposition coating process in automotive production processes comprises electrodepositing a charged polymer on a conductive material (car body) together with electrophoresis and electrolysis of water to form a water-soluble coat. This electrodeposition coating process aims mainly to form a uniform coating film on a complex car body structure while imparting corrosion resistance and adhesion, but has a problem in that it is carried out by a non-environmentally-friendly wet dipping process. Also, in the primer coating process which is carried out by an electrostatic spray coating process in which a solvent is scattered, there are problems in that the coating process is complex and the work environment is harsh.

Accordingly, as an approach to overcome these process problems and maximize production efficiency, a coating process technology employing a roll coating process has recently received a great deal of attention. Also, in the field of finished vehicles, an attempt to develop and use this technology has been made mainly in advanced countries. The roll coating process is a system in which a coating is first applied to a metal sheet, and the coated metal sheet is then subjected to cutting, forming and/or assembling processes, as required, thus providing various products. A metal sheet coated before its processing is generally called a “pre-coated metal”, and a coating which is used to prepare the pre-coated metal is called a “PCM coating”. This coating system in which a metal sheet is coated before its processing in order to simultaneously impart corrosion resistance, processability and other physical properties to the metal sheet is being advantageously applied in various industrial fields.

Such PCM coatings include a pre-sealed coating, which makes it possible to eliminate a sealing and cavity waxing process that is a secondary corrosion-preventing process in an automotive painting process, and a pre-primed coating which makes it possible to eliminate an automotive electrodeposition coating process and/or an automotive primer coating process. With respect to patent documents relating to such PCM coatings, Korean Patent Registration No. 10-0361654 (published on Nov. 22, 2002) discloses a polyester resin composition for PCM coating having a weight-average molecular weight of 10,000-35,000, wherein a glycol compound of total glycol content of 20-100 including bisphenol-A, bisphenol-F and/or bisphenol-S to which ethylene oxide or propylene oxide is added and which has a hydroxyl equivalent weight of 100-400 is polycondensed with a dibasic acid compound including aromatic acid. Moreover, Korean Patent Registration No. 10-0453383 (published on May 3, 2005) discloses a polyester resin coating composition for non-pollution PCM exterior material having excellent pollution resistance, acid resistance and self-cleaning ability, which is prepared by adding an effective amount of polysilicate as a surface modifier to a PCM coating composition containing polyester resin and melamine resin as main components, malonate-blocked isocyanate as a curing aid, and amine- or epoxy-blocked sulfonic acid as an accelerator. The above compositions improve the processability of a steel sheet and the adhesion between a base and a top coat or have excellent pollution resistance, acid resistance and self-cleaning ability. However, PCM steel sheets coated with such compositions have reduced weldability compared to non-coated steel sheets due to the electrical resistance of the resin contained in the compositions. For this reason, these compositions cannot impart weldability comparable to that attainable by a coating process carried out before processing of steel sheets, when a complex electrodeposition coating process is not carried out. Accordingly, it is impossible to use these compositions as pre-primed coatings.

In addition, in an attempt to impart weldability to a steel sheet which has undergone a coating process, Korean Patent Publication No. 1997-0005447 (published on Apr. 16, 1997) discloses a weldable colored steel sheet having a surface plated with zinc or a zinc alloy, and carrying a chromate film formed on the plated surface and having a coating weight of 1 to 200 mg/m² in terms of metallic chromium, and a colored film formed on the chromate film from a composition comprising 100 parts by weight of a thermosetting resin as a base resin and 1 to 200 parts by weight of a dye as a coloring agent, the resin and the dye being both water-soluble or water-dispersible, the colored film having a thickness of 0.3 to 3.0 microns, and a color other than black. In this patent publication, a coloring agent is used to form a colored film on a steel sheet, thus manufacturing a weldable and colored steel sheet having an excellent appearance which is suitable for use in making electric appliances for domestic use, machines for office use, copying machines, etc. However, when the technology disclosed in this patent publication is applied in an electrodeposition coating process for an automotive steel sheet, there is a problem in that the adhesion between a pretreated steel sheet and a primer coat is reduced so that the adhesion of the coating film to the steel sheet is reduced.

Accordingly, it is required to develop a weldable pre-primed coating composition which can maximize the weldability, corrosion resistance and processability of a steel sheet after processing of the steel sheet and makes it possible to eliminate an existing electrodeposition process in automotive painting processes to reduce the number of coating facilities and maximize productivity. Previously, the present inventors developed a pre-primed coating composition containing zinc powder as metal powder and filed a patent application for that coating composition (Korean Patent Application No. 2009-117196). The present inventors have made efforts to develop a pre-primed coating composition having further improved properties and, as a result, have developed a pre-primed coating composition including carbon nanotubes having very excellent mechanical, physical and thermal properties, thereby completing the present invention.

### SUMMARY OF THE INVENTION

The present invention has been made in order to solve the above-described problems occurring in the prior art, and it is an object of the present invention to provide a weldable pre-primed coating composition for automotive OEM, which can further improve the corrosion resistance and coating adhesion attainable by an existing electrodeposition system and maximize the formability and weldability of a metal sheet after processing of the metal sheet by applying elastic polymer resin.

Another object of the present invention is to provide a weldable pre-primed coating composition which contains polyester polyol and epoxy resin as binder resins, melamine resin as a crosslinker, strontium chromate as an anti-corrosive pigment, zinc (Zn) dust and aluminum powder as conductive metal powders, and carbon nanotubes (CNTs) for improving weldability, and thus has good storage stability while allowing a metal sheet coated with the composition to have very excellent formability and weldability after its processing because the composition contains the anti-corrosive pigment, the conductive metal powders and carbon nanotubes (CNTs) in the range capable of further improving the corrosion resistance and coating adhesion attainable by an existing electrodeposition coating system.

Still another object of the present invention is to provide a method of coating a metal sheet with the above-described weldable pre-primed coating composition by a roll coating process so as to make it possible to eliminate not only an electrodeposition coating process which is carried out an existing non-environmentally-friendly wet dipping process, but also an electrostatic spray primer coating process which is carried out by an electrostatic spray coating process in which a solvent is scattered, whereby the metal sheet coated with the pre-primed coating composition has very excellent formability and weldability after its processing, and accordingly, the coating method makes it possible to reduce the number of automotive coating processes, thereby greatly contributing to an increase in productivity, a reduction in energy and an improvement in a work environment.

To achieve the above objects, the present invention provides a weldable pre-primed composition including: 20-30 parts by weight of polyester polyol and 2-5 parts by weight of epoxy resin as binder resins; 4-10 parts by weight of melamine resin as a crosslinker; 5-10 parts by weight of strontium chromate as an anti-corrosive pigment; 10-20 parts by weight of zinc (Zn) dust and 10-20 parts by weight of aluminum powder as conductive metal powders; 10-20 parts by weight of carbon nanotubes, 5-15 parts by weight of a solvent; and 1.0-3.0 parts by weight of additives.

In the coating composition of the present invention, the polyester polyol preferably has a weight-average molecular weight (Mw) of 4500-8500, and the polyester polyol is preferably an elastomeric polyester polyol having a hydroxyl (OH) value of 20-40 mg KOH/g.

Also, the epoxy resin that is used in the present invention is preferably one or more selected from the group consisting of glycidylether type epoxy resins, glycidylamine type epoxy resins, alicyclic epoxy resins, glycidyl ester resins, heterocyclic epoxy resins, and urethane-modified epoxy resins, wherein the glycidylether type epoxy resins include bisphenol A type, bisphenol F type, brominated bisphenol A type, hydrogenated bisphenol A type, bisphenol S type, bisphenol AF type, biphenyl type, naphthalene type, fluorene type, phenol novolac type, cresol novolac type, DPP novolac type, trifunctional type, tris(hydroxyphenyl)methane type, and tetraphenylolethane type epoxy resins, and the glycidylamine type epoxy resin include tetraglycidyldiaminodiphenylmethane, triglycidyl isocyanurate, hydantoin type, 1,3-bis(N,N-diglycidylaminomethyl)cyclohexane, aminophenol type, aniline type, and toluidine type epoxy resins.

Furthermore, the melamine resin that is used in the present invention is one or more selected from the group consisting of alkyletherified melamine resins, such as hexamethoxymethylmelamine resin, butoxymelamine resin and methylolated melamine resin.

In addition, the pre-primed coating composition of the present invention preferably additionally includes 0.5-2.0 parts by weight of block isocyanate as a crosslinker.

As described above, the weldable pre-primed coating composition of the present invention, comprising binder resins, a crosslinker, an anti-corrosive pigment, zinc dust and aluminum powder as conductive metal powders, carbon nanotubes, etc., can be applied to a metal sheet before processing of the metal sheet to maximize the weldability, adhesion, corrosion resistance and processability of the metal sheet. Also, the coating composition of the present invention can be applied to a metal sheet by a roll coating process to make it possible to eliminate not only an existing electrodeposition process which is carried out by a non-environmentally-friendly wet dipping process, but also an electrostatic spray primer coating process which is carried out by an electrostatic spray coating process in which a solvent is scattered, whereby the metal sheet coated with the pre-primed coating composition of the present invention has very excellent formability and weldability after its processing. Accordingly, it is expected that the pre-primed coating composition will greatly contribute to an increase in productivity, a reduction in energy and an improvement in a work environment owing to a reduction in the number of complex automotive coating processes.

### DETAILED DESCRIPTION OF THE PREFERRED EMBODIMENT

The present invention to accomplish the above effects is directed to a weldable pre-primed coating composition for automotive OEM and a coating method thereof. Preferred embodiments of the present invention will be described hereinafter in detail. It is to be noted that in the following descriptions, only portions required to understand the present invention will be described and the description of portions other than the above required portions will be omitted to prevent the gist of the present invention from being made unclear.

The present invention is directed to a weldable pre-primed composition including: 20-30 parts by weight of polyester polyol and 2-5 parts by weight of epoxy resin as binder resins; 4-10 parts by weight of melamine resin as a crosslinker; 5-10 parts by weight of strontium chromate as an anti-corrosive pigment; 10-20 parts by weight of zinc (Zn) dust and 10-20 parts by weight of aluminum powder as conductive metal powders; 10-20 parts by weight of carbon nanotubes, 5-15 parts by weight of a solvent; and 1.0-3.0 parts by weight of additives.

In general, an electrodeposition coating which is used in an electromotive coating process has a major object to increase coating adhesion to a base and improve corrosion resistance and is applied by a dipping process in order to enhance the appearance of a primer coat and a top coat which are applied on the electrodeposition coat. The automotive coating process comprises an electrodeposition coating process for forming an electrodeposition coat, a primer coating process for improving corrosion resistance and smoothness and increasing the adhesion between the electrodeposition coat and a top coat, and a top coating process for forming a top coat providing the final appearance while exhibiting gloss, clarity and durability. A coating which is used to eliminate the automotive electrodeposition coating or primer coating process is termed a “pre-primed coating”.

The pre-primed coating composition for automotive OEM of the present invention allows a steel sheet for automobiles to be coated before its processing. Specifically, the coating composition of the present invention is applied to a steel sheet by roll coating at high speed before processing of the steel sheet, and then the coated steel sheet is cut, assembled and welded, thus producing a product.

In the present invention, the binder resin polyester polyol is used to allow the pre-primed coating composition, which is applied by roll coating, to ensure all the physical properties of an electrodeposition coating. In order for a metal sheet coated with the pre-primed coating composition of the present invention to have formability, the binder resin polyester polyol is preferably an elastomeric polyester polyol and is used in an amount of 20-30 parts by weight based on 100 parts by weight of the composition. If the polyester polyol is used in an amount of less than 20 parts by weight, the corrosion resistance of the composition and the adhesion of the composition to a steel sheet will be insufficient and the conductive metal pigment powder will deteriorate the appearance of the steel sheet surface. If the polyester polyol is used in an amount of more than 30 parts by weight, the appearance of the resulting coating film will be somewhat improved, but the weldability of the steel sheet coated with the composition will be deteriorated, and the chipping resistance of the coated steel sheet will be significantly deteriorated.

In order for a steel sheet coated with the pre-primed coating composition of the present invention to have high corrosion resistance and formability, the polyester polyol preferably has a weight-average molecular weight (Mw) of 4500-8500 in view of increasing the workability, coating strength and weather resistance of the composition while reducing the glass transition temperature (Tg) of the composition. If the weight-average molecular weight (Mw) of the polyester polyol is less than 4500, the physical properties of the coating film formed of the composition will be deteriorated due to a decrease in Tg, the polyester polyol will not sufficiently react with the crosslinker melamine resin so that the flexibility of the coating film will be reduced, and the metal pigment will be rapidly settled in the coating composition. On the other hand, if the weight-average molecular weight (Mw) of the polyester polyol is more than 8500, the viscosity of the coating composition will be increased to deteriorate the appearance of the coating film applied by roll coating.

In order to increase the flexibility, heat resistance and reactivity of the dried coating film, the elastomeric polyester polyol is prepared using main glycol and a hydroxyl monomer, and in order to achieve a suitable degree of crosslinking with melamine, the polyester polyol preferably has a hydroxyl (OH) value of 20-40 mg KOH/g. If the hydroxyl value is less than 20 mg KOH/g, the crosslinking of the coating film formed of the composition can be reduced, and if the hydroxyl value is more than 40 mg KOH/g, popping can occur during work, and the weather resistance of the coating film can be deteriorated. More preferably, the hydroxyl group is about 30 mg KOH/g.

Epoxy resin which is used in the composition of the present invention serves to enhance chipping resistance after top coating and is used in an amount of 2-5 parts by weight based on 100 parts by weight of the composition. If the epoxy resin is used in an amount of less than 2 parts by weight, the effect of enhancing the physical properties of the composition after coating will be insignificant, and if the epoxy resin is used in an amount of more than 5 parts by weight, the chipping resistance of the coating film formed of the composition will be improved, but the surface of the coating film will become hard to reduce formability.

In addition, the epoxy resin that can be used in the present invention is preferably one or more selected from the group consisting of glycidylether type epoxy resins, glycidylamine type epoxy resins, alicyclic epoxy resins, glycidyl ester resins, heterocyclic epoxy resins, and urethane-modified epoxy resins, wherein the glycidylether type epoxy resins include bisphenol A type, bisphenol F type, brominated bisphenol A type, hydrogenated bisphenol A type, bisphenol S type, bisphenol AF type, biphenyl type, naphthalene type, fluorene type, phenol novolac type, cresol novolac type, DPP novolac type, trifunctional type, tris(hydroxyphenyl)methane type, and tetraphenylolethane type epoxy resins, and the glycidylamine type epoxy resin include tetraglycidyldiaminodiphenylmethane, triglycidyl isocyanurate, hydantoin type, 1,3-bis(N,N-diglycidylaminomethyl)cyclohexane, aminophenol type, aniline type, and toluidine type epoxy resins. The epoxy resin is most preferably, but not particularly limited to, the bisphenol A type epoxy resin.

Melamine resin which is used in the coating composition of the present invention is obtained by polymerization of melamine with alcohol and serves to facilitate crosslinking with the binder resin inside and outside the coating film formed of the composition. It is semi-thermoset during drying of the coating film such that the coating film has durability higher than an existing thermoplastic coating film. It is used in an amount of 4-10 parts by weight based on 100 parts by weight of the composition. If the melamine resin is used in an amount of less than 4 parts by weight, the effect of enhancing the physical properties of the coating composition will be insignificant, and if it is used in an amount of more than 10 parts by weight, the thermosetting property of the coating composition will be increased so that the flexibility of the coating film formed of the composition will be decreased, whereby the impact resistance of the coating film can be reduced while the coating film can be broken.

Furthermore, the melamine resin that can be used in the present invention is preferably, but is not particularly limited to, one or more selected from the group consisting of alkyletherified melamine resins, such as hexamethoxymethylmelamine resin, butoxymelamine resin and methylolated melamine resin.

Also, in order to improve formability and the coating adhesion of the primer surface after application of the pre-primed coating composition, the composition of the present invention may additionally comprise 0.5-2.0 parts by weight of block isocyanate as a crosslinker in addition to the crosslinker melamine.

Strontium chromate which is used in the composition of the present invention is a light-yellow or yellow anti-corrosive pigment serving to improve the anti-rust property and corrosion resistance of a steel sheet after processing of the steel sheet and to improve the hiding powder of the coating film formed of the composition and to maximize the corrosion resistance after application of a top coat and is used in an amount of 5-10 parts by weight based on 100 parts by weight of the composition. If strontium chromate is used in an amount of less than 5 parts by weight, the corrosion resistance of the steel sheet coated with the coating composition will be somewhat reduced, and if it is used in an amount of more than 10 parts by weight, the specific gravity of the coating composition will be increased to reduce the storage stability of the coating composition, and the amount of metal pigment zinc (Zn) dust and aluminum powder used will be limited so that the weldability of the coating film formed of the composition will be adversely affected.

Zinc dust which is used in the composition of the present invention is conductive metal powder serving to improve the weldability and corrosion resistance of a metal sheet coated with the composition. Because zinc dust uniformly distributed on the surface of a coating film formed of the composition has an ionization tendency higher than that of a base (metal sheet), the zinc dust has a great effect on the prevention of corrosion of the base. The zinc dust is used in an amount of 10-20 parts by weight based on 100 parts by weight of the composition. If zinc dust is used in an amount of less than 10 parts by weight, the effect of improving the weldability and corrosion resistance of a metal sheet coated with the composition will be insignificant, and if it is used in an amount of more than 20 parts by weight, it will improve the weldability and corrosion resistance of the metal sheet, but it will reduce the storage stability of the coating composition so as to be rapidly settled in the composition and will also adversely affect the appearance of the coating film formed of the composition.

In order to maximize the weldability of a metal sheet after its processing, the zinc dust that is used in the present invention is preferably amorphous zinc dust having a mean particle size of 3-5 μm which has an ionization tendency higher than that of iron. If the mean particle size of the zinc dust is less than 3 μm, it will improve the appearance of the coating film, but the area of contact between the zinc dust particles will be decreased so that the electrical conductivity of the steel sheet surface coated with the composition will be decreased to reduce weldability. If the zinc dust has a mean particle size of more than 5 μm, it will maximize corrosion resistance and weldability, but it will significantly deteriorate the appearance of the coating film to make it difficult to apply primer and top coats. Because the coating film formed from the pre-primed coating composition of the present invention preferably has 8-10 μm (on a dry basis), if the particle size of zinc dust is more than 5 μm, the appearance of the dried coating film will be significantly deteriorated, and when primer and top coats are applied on the pre-primed coating film, the poor appearance of the pre-primed coating film will appear through the top coat.

Aluminum powder which is used in the composition of the present invention is conductive metal powder serving to maximize weldability and corrosion resistance, like the zinc dust. It has high electrical conductivity and low specific gravity compared to those of zinc dust and serves to primarily prevent the corrosion of the zinc dust. It is used in amount of 10-20 parts by weight based on 100 parts by weight of the composition. If aluminum powder is used in an amount of less than 10 parts by weight, the weldability of a metal sheet coated with the composition will be reduced, and if it is used in an amount of more than 20 parts by weight, the weldability of the metal sheet will be improved, but the solid content of metal pigments in the coating composition will be increased to increase the viscosity of the coating composition so as to rapidly reduce the dispersity of the composition, and this decrease in dispersity will result in a significant deterioration in the appearance of the coating film formed of the composition.

Aluminum powder that is used in the present invention preferably is spherical aluminum powder having a mean particle size of 3-6 μm. If the aluminum powder has a mean particle size of less than 3 μm, the appearance of the coating film formed from the composition and the dispersity of the coating composition will be improved, but the area of contact between the metal pigment powder particles will be reduced to deteriorate the weldability of a metal sheet coated with the composition. If the aluminum powder has a mean particle size of more than 6 μm, the weldability of the metal sheet will be improved, but the dispersity of the composition and the appearance of the coating film will be deteriorated.

Carbon nanotubes (CNTs) which are used in the present invention are one kind of carbon allotrope in which carbon atoms are coupled in a hexagonal honeycomb-like arrangement to form a tube-like shape. They have a diameter of nanometer scale and exhibit very excellent mechanical, physical, electrical and thermal properties, and thus the possible application thereof in a wide range of fields, including electrical, electronic, telecommunication, energy, biological, aerospace and automotive fields, has been suggested. Carbon nanotubes (CNTs) can be classified, according to the number of walls consisting of graphite sheets, into single-walled carbon nanotubes (SWCNTs) and multiwalled carbon nanotubes (MWCNTs).

Carbon nanotubes which are used in the present invention are multiwalled carbon nanotubes which have an aspect ratio of 10³-10⁴ and an electrical conductivity of 6000 S/cm and are used as a paste (solid content: 3%) dispersed in ethyl cellosolve. In the present invention, carbon nanotubes are used in a manner in which they are added later to the coating composition. If carbon nanotubes are used in an amount of less than 10 parts by weight based on 100 parts by weight of the composition, the effect of improving the weldability of a metal sheet at a film thickness of more than 8 μm will be insignificant, and if they are used in an amount of more than 20 parts by weight, they will reduce the viscosity of the coating composition and limit the amounts of other materials used. For this reason, carbon nanotubes are preferably used in an amount of less than 20 parts by weight.

A solvent which is used in the present invention may be an alcoholic solvent, which is used for compatibility with the binder resin, an aromatic solvent which is used to form a uniform coating film by degreasing the surface of a base material during a coating process, or a mixture of the alcoholic solvent and the aromatic solvent. The solvent is used in an amount of 5-15 parts by weight based on 100 parts by weight of the composition. If the solvent is used in an amount of less than 5 parts by weight, the coating property of the composition can be reduced due to a decrease in drying speed and a decrease in the effect, of degreasing the surface of a base (metal sheet). If the solvent is used in an amount of more than 15 parts by weight, it can reduce the coating property of the composition due to a decrease in compatibility with the binder resin.

The alcoholic solvent may be one or more selected from the group consisting of methyl alcohol, ethyl alcohol, isopropyl alcohol, and n-butyl alcohol, and the aromatic solvent may be one or more selected from the group consisting of toluene and xylene. Preferably, the aromatic solvent is used in order to prevent pinholes from occurring during high-speed drying in an oven.

The pre-primed coating composition of the present invention is applied not by bell coating or spray coating, but by roll coating, and thus is dried at high speed in a high-temperature oven without setting time after coating. Thus, roll stripes, flushing starvation, shutter marks, bubbles, etc. can occur during the roll coating process. In order to prevent the occurrence of such defects so as to improve the leveling of the resulting coating film, the coating composition of the present invention may comprise 1.0-3.0 parts by weight of additives.

An additive that can be used in the present invention is not specifically limited and may be one or more selected from the group consisting of a catalyst having a dissociation temperature between 50° C. and 70° C., a dispersant serving to improve dispersion stability to uniformly disperse zinc (Zn) dust and aluminum powder on the coating film surface so as to maximize weldability while increasing the storage stability of the coating composition, an anti-settling agent, an antioxidant, a UV blocker, and a defoaming agent.

Hereinafter, a method of coating a steel sheet with the weldable pre-primed coating composition of the present invention will be described.

The method of coating a steel sheet with the pre-primed coating composition of the present invention comprises:

a pretreatment step (S1) of degreasing the steel sheet and pretreating the degreased steel sheet with phosphate;

a coating step (S2) of coating the steel sheet of step (S1) with a pre-primed coating composition by a roll coater to form a coating film having a thickness of 8-10 μm on a dry basis; and

a drying step (S3) of baking the coated steel sheet of step (S2) in a high-temperature oven at a peak metal temperature between 200° C. and 210° C., and then cooling the baked steel sheet in air at room temperature to cure the coating film.

The steel sheet that is used in the present invention is preferably a galvannealed (GA) steel sheet or a hot-dipped galvanized (GI) steel sheet, such as a GA, GI or electro-galvanized (EGI) steel sheet.

Because the pre-primed coating composition used in the method of the present invention has been described in detail above, the detailed description thereof will be omitted.

Also, a primer coat is formed on the pre-primed coating film by a conventional electrostatic spray process, and a top coat is formed on the primer coat using a solid type coating and a metallic type coating containing mica or metal powder such as aluminum powder. The primer coating process and the top coating process are not specifically limited and can be applied according to various methods. Particularly, the coatings and processes which are used in the primer and top coating processes are not critical to the present invention.

Accordingly, the weldable pre-primed coating composition of the present invention has good storage stability and exhibits the corrosion resistance and coating adhesion attainable by an existing electrodeposition coating, and a metal sheet coated with the pre-primed coating composition shows very excellent formability and weldability after its processing. Thus, the pre-primed coating composition of the present invention makes it possible to eliminate not only an existing electrodeposition coating process which is carried by a non-environmentally-friendly wet dipping process, but also an electrostatic primer coating process which is carried out by an electrostatic spray coating process in which a solvent is scattered. Accordingly, when the weldable pre-primed coating composition of the present invention is applied in existing automotive production lines, it will greatly contribute to an increase in productivity, a reduction in energy and an improvement in a work environment.

Hereinafter, the present invention will be described in further detail with reference to examples, but the scope of the present invention is not limited by these examples.

### 1. Selection of Conductive Metal Powder

### Example 1

A pre-primed coating composition was prepared which consisted of 25 parts by weight of polyester polyol and 4 parts by weight of epoxy resin as binder resins, 6 parts by weight of melamine resin and 1.0 part by weight of block isocynate as crosslinkers, 10 parts by weight of strontium chromate as an anti-corrosive pigment, 15 parts by weight of zinc (Zn) dust having a mean particle size of 3-5 μm as conductive metal powder, 15 parts by weight of aluminum powder having a mean particle size of 3-6 μm as conductive metal powder, 20 parts by weight of a solvent, and additives, including 1.0 part by weight of a dispersant (BYK-110), 1.0 part by weight of a catalyst and 1.0 part by weight of an anti-settling agent.

### Comparative Example 1

A coating composition was prepared in the same manner as Example 1, except that 30 parts by weight of spherical aluminum powder having a mean particle size of 2 an was used as conductive metal powder.

### Comparative Example 2

A coating composition was prepared in the same manner as Example 1, except that 20 parts by weight of spherical aluminum powder having a mean particle size of 8 μm was used as conductive metal powder.

### Comparative Example 3

A coating composition was prepared in the same manner as Example 1, except that 25 parts by weight of spherical silver powder having a mean particle size of 1-2 μm was used as conductive metal powder.

### Comparative Example 4

A coating composition was prepared in the same manner as Example 1, except that 40 parts by weight of flat silver powder having a mean particle size of 4 μm was used as conductive metal powder.

### 2. Evaluation of Weldability and Corrosion Resistance According to Pretreatment and the Kind of Conductive Metal Powder

Various methods can be used to evaluate weldability, but in the present invention, weldability was evaluated by analyzing the degree of damage to the welding rod tip during a welding process and an image of the welded portion of a steel sheet. After a uncoated galvannealed (GA) steel sheet pretreated with phosphate has been welded, the surface of the welding rod tip and the welded portion of the steel sheet were imaged and analyzed. To analyze the surface image of the welding rod tip, the image was photographed using a video microscope (PW ICS-305B, Pluswin, Korea). Also, the size of the welded portion was measured and calculated using image analysis software (PW IT Plus 4.0, Pluswin, Korea), and the measurement results are shown in Table 1 below.

TABLE 1

| | | | | | | Calibra- | |
|---|---|---|---|---|---|---|---|
| | | | | | Calculated | ting | Welding |
| Samples | R₁ | R₁₅₀₀ | Rᵢₙᵢ | Rₜₒₜ | value | constant | Number |
| GA | 3.311 | 5.11 | 3.154 | 6.854 | 3085 | 1.1 | 3500 |
| (Bare) | | | | | | | |

To evaluate weldability and corrosion resistance, each of a non-pretreated galvannealed (GA) steel sheet, a galvannealed (GA) steel sheet pretreated with chromate, a galvannealed (GA) steel sheet pretreated with phosphate, and a galvannealed (GA) steel sheet coated with the pre-primed coating composition prepared in each of Examples 1 and Comparative Examples 1 to 4 was welded to a GA sample. Then, the surface of the welding rod tip and the welded portion of the steel sheet were imaged and analyzed, after which the welding number resulting from the image analysis of the welding rod was calculated as shown in Table 1 above to evaluate weldability and corrosion resistance. The evaluation results are shown in Table 2 below.

Herein, for evaluation under the same conditions, each of the coating compositions of Example 1 and Comparative Examples 1 to 4 was formed into a film to have a constant thickness of 4-5 μm on a dry basis.

TABLE 2

| | | Pretreated | Pretreated | | Comparative | | | |
|---|---|---|---|---|---|---|---|---|
| | Non | with | with | Examples | Examples | | | |
| | pretreatment | chromate | phosphate | 1 | 1 | 2 | 3 | 4 |
| Weldability | ⊚ | ⊚ | ⊚ | ⊚ | ◯ | □ | Δ | ⊚ |
| Corrosion | X | X | ⊚ | ⊚ | ⊚ | ◯ | Δ | X |
| resistance | | | | | | | | |

1) Weldability: A coating composition was prepared according to each of Example 1 and Comparative Examples 1 to 4, and each of the prepared coating compositions was applied to the front and back sides of a steel sheet sample (GA, 0.8T) to a predetermined thickness (on a dry basis) using a bar coater. Then, each of the coated steel sheets was baked in an automatic discharge oven (Taesung Engineering, Korea) at a PMT between 200° C. and 210° C., thus preparing test samples (30×30 cm). Each of the samples was welded using a DC survomotor type spot welding machine under the following conditions: welding current: 8 kA, pressure: 20 kgf, and conducting time: 100 msec. Then, the welding number was evaluated. The welding rod used was made of a dome-type chromium/copper alloy. In evaluation, two sheets of samples were put one upon another and welded 2000 times. Also, two sheets of each of non-pretreated GA, GA pretreated with chromate, and non-coated GA pretreated with phosphate were put one upon another and welded 2000 times. The welding number was calculated according to the following equation:

$$Welding Number = \frac{{R}_{tot} - {R}_{ini}}{{R}_{1500} - {R}_{1}} \times 100$$

where Rₜₒₜ=total radius of welding rod, Rᵢₙᵢ=initial radius of welding rod tip, R₁=radius of welding rod after 1^{st} welding, and R₁₅₀₀=radius of welding after 2000^{nd} welding.

Evaluation Criteria of Weldability:
⊚: welding number of 2000 or more
O: welding number of 1500 or more to less than 1800
□: welding number of 1200 or more to less than 1500
Δ: welding number of 1000 or more to less than 1200
X: welding number of less than 1000

2) Corrosion resistance: Each of dried samples (10×20 cm) was x-cut, and then put in a salt spray tester (SST). According to the degree of occurrence of bleeding, red rust or white rust on the surface of the sample, the corrosion resistance of the sample was evaluated. The evaluation criteria are as follows:
⊚: occurrence of red rust, white rust or bleeding at 1500 hours or, more
O occurrence of red rust, white rust or bleeding at 1000-1500 hours
Δ: occurrence of red rust, white rust or bleeding at 800-1000 hours
X: occurrence of red rust, white rust or bleeding at 800 hours or less

As can be seen from the results in Table 2 above, the application of Zn dust like the case of Example 1 showed the most excellent weldability or corrosion resistance. In the case in which solver powder was applied, weldability was excellent, but corrosion resistance was significantly low. Also, weldability did not change depending on pretreatment, but corrosion resistance greatly changed depending on pretreatment. The case in which the steel sheet surface was pretreated with phosphate was most advantageous in terms of corrosion resistance.

### 2. Preparation of Weldable Pre-Primed Coating Compositions

### Example 2

A pre-primed coating composition was prepared which consisted of 24 parts by weight of polyester polyol and 4 parts by weight of epoxy resin as binder resins, 6 parts by weight of melamine resin and 1.0 part by weight of block isocynate as crosslinkers, 8 parts by weight of strontium chromate as an anti-corrosive pigment, 12 parts by weight of zinc (Zn) dust as conductive metal powder, 20 parts by weight of aluminum powder as conductive metal powder, 12 parts by weight of carbon nanotubes, 10 parts by weight of a solvent, and additives, including 1.0 part by weight of a dispersant (BYK-110), 1.0 part by weight of a catalyst and 1.0 part by weight of an anti-settling agent.

### Example 3

A pre-primed coating composition was prepared which consisted of 30 parts by weight of polyester polyol and 2 parts by weight of epoxy resin as binder resins, 4 parts by weight of melamine resin and 1.0 part by weight of block isocynate as crosslinkers, 5 parts by weight of strontium chromate as an anti-corrosive pigment, 15 parts by weight of zinc (Zn) dust as conductive metal powder, 25 parts by weight of aluminum powder as conductive metal powder, 18 parts by weight of carbon nanotubes, 10 parts by weight of a solvent, and additives, including 1.0 part by weight of a dispersant (BYK-110), 1.0 part by weight of a catalyst and 1.0 part by weight of an anti-settling agent.

### Comparative Example 5

A pre-primed coating composition was prepared which consisted of 28 parts by weight of polyester polyol and 2 parts by weight of epoxy resin as binder resins, 3 parts by weight of melamine resin and 1.0 part by weight of block isocynate as crosslinkers, 22 parts by weight of strontium chromate as an anti-corrosive pigment, 10 parts by weight of zinc (Zn) dust as conductive metal powder, 18 parts by weight of aluminum powder as conductive metal powder, 3 parts by weight of carbon nanotubes, 10 parts by weight of a solvent, and additives, including 1.0 part by weight of a dispersant (BYK-110), 1.0 part by weight of a catalyst and 1.0 part by weight of an anti-settling agent.

### Comparative Example 6

A pre-primed coating composition was prepared which consisted of 33 parts by weight of polyester polyol as a binder resin, 3 parts by weight of melamine resin and 1.0 part by weight of block isocynate as crosslinkers, 15 parts by weight of strontium chromate as an anti-corrosive pigment, 5 parts by weight of zinc (Zn) dust as conductive metal powder, 12 parts by weight of aluminum powder as conductive metal powder, 22 parts by weight of carbon nanotubes, 6 parts by weight of a solvent, and additives, including 1.0 part by weight of a dispersant (BYK-110), 1.0 part by weight of a catalyst and 1.0 part by weight of an anti-settling agent.

### Comparative Example 7

A pre-primed coating composition was prepared which consisted of 26 parts by weight of polyester polyol as a binder resin, 3 parts by weight of melamine resin and 1.0 part by weight of block isocynate as crosslinkers, 5 parts by weight of strontium chromate as an anti-corrosive pigment, 22 parts by weight of zinc (Zn) dust as conductive metal powder, 25 parts by weight of aluminum powder as conductive metal powder, 7 parts by weight of carbon nanotubes, 8 parts by weight of a solvent, and additives, including 1.0 part by weight of a dispersant (BYK-110), 1.0 part by weight of a catalyst and 1.0 part by weight of an anti-settling agent.

### Comparative Example 8

A pre-primed coating composition was prepared which consisted of 22 parts by weight of polyester polyol as a binder resin, 3 parts by weight of melamine resin and 1.0 part by weight of block isocynate as crosslinkers, 3 parts by weight of strontium chromate as an anti-corrosive pigment, 28 parts by weight of zinc (Zn) dust as conductive metal powder, 25 parts by weight of aluminum powder as conductive metal powder, 10 parts by weight of carbon nanotubes, 8 parts by weight of a solvent, and additives, including 1.0 part by weight of a dispersant (BYK-110), 1.0 part by weight of a catalyst and 1.0 part by weight of an anti-settling agent.

TABLE 3

| | | Ex. | Ex. | Comp. | Comp. | Comp. | Comp. |
|---|---|---|---|---|---|---|---|
| | | 2 | 3 | Ex. 5 | Ex. 6 | Ex. 7 | Ex. 8 |
| Resin | Polyester | 24 | 30 | 28 | 33 | 26 | 22 |
| | Melamine | 6 | 4 | 3 | 3 | 3 | 3 |
| | resin | | | | | | |
| | Epoxy | 4 | 2 | 2 | — | — | — |
| | resin | | | | | | |
| | Block | 1 | 1 | 1 | 1 | 1 | 1 |
| | isocynate | | | | | | |
| Anti- | Strontium | 8 | 5 | 22 | 15 | 5 | 3 |
| corrosive | chromate | | | | | | |
| pigment | | | | | | | |
| Metal | Zinc (Zn) | 12 | 15 | 10 | 5 | 22 | 28 |
| powder | dust | | | | | | |
| | Aluminum | 20 | 15 | 18 | 12 | 25 | 25 |
| | powder | | | | | | |
| Paste | Carbon | 12 | 18 | 3 | 22 | 7 | 10 |
| | nanotubes | | | | | | |
| Additives | Dispersant | 1.0 | 1.0 | 1.0 | 1.0 | 1.0 | 1.0 |
| | (BYK-110) | | | | | | |
| | Catalyst | 1.0 | 1.0 | 1.0 | 1.0 | 1.0 | 1.0 |
| | Anti- | 1.0 | 1.0 | 1.0 | 1.0 | 1.0 | 1.0 |
| | settling | | | | | | |
| | agent | | | | | | |
| Solvent | Xylene | 3 | 2 | 2 | 1 | 2 | 2 |
| | PMA | 5 | 4 | 4 | 2 | 2 | 2 |
| | Solvesso | 5 | 4 | 4 | 3 | 4 | 4 |
| | 150 | | | | | | |

### 3. Evaluation of Physical Properties of Weldable Pre-Primed Coating Compositions

The wet physical properties (including storage stability, viscosity and specific gravity) and weldability, corrosion resistance and other physical properties of the coating compositions prepared in Examples 2 and 3 and Comparative Examples 5 to 8 were evaluated, and the evaluation results are shown in Table 4 below.

TABLE 4

| | | Ex. | Ex. | Comp. | Comp. | Comp. | Comp. |
|---|---|---|---|---|---|---|---|
| | | 2 | 3 | Ex. 5 | Ex. 6 | Ex. 7 | Ex. 8 |
| Wet | Viscosity | 45 | 47 | 42 | 36 | 52 | 50 |
| physical | (Second, Ford | | | | | | |
| properties | Cup#4@20) | | | | | | |
| | Specific | 1.28 | 1.26 | 1.29 | 1.24 | 1.35 | 1.36 |
| | gravity | | | | | | |
| | Solid | 59.5 | 56.5 | 69.2 | 53.5 | 69.1 | 70.7 |
| | content(%) | | | | | | |
| | Storage | ⊚ | ⊚ | Δ | ⊚ | X | X |
| | stability | | | | | | |
| Dry | Corrosion | ⊚ | ⊚ | ◯ | Δ | X | X |
| physical | resistance | | | | | | |
| properties | (SST, 35, | | | | | | |
| | 5% salt) | | | | | | |
| | Weldability | ⊚ | ⊚ | X | ◯ | ⊚ | ⊚ |
| | Rubbing | ⊚ | ⊚ | Δ | ◯ | ◯ | X |
| | test(MEK) | | | | | | |
| | T-Bend | 3T | 3T | 3T | 2T | 1T | 1T |
| | Cupping/ | ⊚ | ⊚ | ⊚ | ⊚ | X | X |
| | Adhesion | | | | | | |
| | Pencil hardness | 2H | 2H | F | 1H | 2H | 2H |

1) Storage stability: Each of the coating compositions was allowed to stand at a temperature of 50° C. for 5 days, and the degree of settlement and the change in viscosity of each composition were evaluated according to the following criteria: ⊚: the change in viscosity after 5 days at 50° C. relative to initial viscosity is within 20 seconds, and the composition is easily stirred with a spatula; O: the change in viscosity is within 20 seconds, and the composition is stirred with a spatula; Δ: the change in viscosity is 20 seconds or more, and the composition is not easily stirred with a spatula; and X: the change in viscosity is 20 seconds or more, and the composition is not stirred with a spatula at all.

2) Corrosion resistance of coating film: Each of the coating compositions was applied to a phosphate-treated galvannealed (GA) steel sheet to a thickness of 8-10 μm (on a dry basis) by a bar coater to prepare samples. The dried film of each of the samples was evaluated. Herein, the film applied to the steel sheet was dried at a PMT of 200-210° C. in an automatic discharge oven (Taesung Engineering, Korea) for 20-30 seconds.

3) The coating film formed on each steel sheet was rubbed using a crockmeter with a MEK solvent, and the peeling of the coating film was evaluated according to the following criteria:
⊚: the coating film is peeled out when the number of rubbings is 10 or more.
O: the coating film is peeled out when the number of rubbings is between 7 and 10.
Δ: the coating film is peeled out when the number of rubbings is between 5 and 7.
X: the coating film is peeled out when the number of rubbings is 4 or less.

To evaluate formability and adhesion to the steel sheet, the dried coating film was cross-cut with a knife at 1-mm intervals to form 10 cut lines lengthwise and widthwise and was stretched using an Erichsen tester. The evaluation was carried out according to following criteria: ⊚: the coating film is peeled when the depth of the cut line is 5 mm or more; and X: the coating film is peeled when the depth of the cut line is less than 5 mm.

As can be seen in Table 4 above, the compositions of Examples 2 and 3 showed the most excellent results with respect to weldability, corrosion resistance and other physical properties. Particularly, because zinc dust, aluminum powder and carbon nanotubes were used in amounts within the ranges specified in the present invention, the compositions of Examples 2 and 3 showed excellent weldability and coating storage stability and good corrosion resistance at a coating thickness of 8-10 μm (on a dry basis). However, in the case of the composition of Comparative Example 5 in which the anti-corrosive pigment was used in an amount larger than the upper limit of the range specified in the present invention and also in which the carbon nanotubes were used in an amount smaller than the lower limit of the range specified in the present invention, the weldability at a coating film thickness larger than 8 μm was very poor. Also, in the case of Comparative Example 6 in which the carbon nanotubes were used in an amount larger than the upper limit of the range specified in the present invention and also in which zinc dust and aluminum powder were used in amounts out of the ranges specified in the present invention, the corrosion resistance was poor. Also, due to the difference in specific gravity from the metal pigment, the layer separation in the liquid phase was severe. Although the carbon nanotubes had the effect of improving weldability, they limited the amount of metal pigment used, and thus had no great effect on the increase in weldability. In Comparative Examples 7 and 8 in which the anti-corrosive pigment was used in an amount smaller than the lower limit of the range specified in the present invention and also in which the conductive metal pigment was used in an amount larger than the upper limit of the range specified in the present invention, weldability was improved; however, storage stability and corrosion resistance were very poor, and the surface of the coating film became brittle so that bending or cupping properties were poor.

### 4. Evaluation of Coating Film on which Primer/Top Coats have Been Applied after Carrying Out a Pre-Primed Coating Process

Galvannealed (GA) steel sheets pretreated with phosphate according to an existing automotive coating process was degreased and subjected to conversion treatment. Then, the pre-primed coating composition of each of Examples 2 and 3 and Comparative Examples 5 to 8 was applied to a steel sheet to a thickness of 8-10 μm (on a dry basis) by roll coating in place of electrodeposition coating. Then, primer/top coating compositions being applied in existing automotive coating processes were applied to the pre-primed coating film, and the physical properties of the coating film were evaluated. The evaluation results are shown in Table 5 below.

TABLE 5

| | | Ex. | Ex. | Comp. | Comp. | Comp. | Comp. |
|---|---|---|---|---|---|---|---|
| | | 2 | 3 | Ex. 5 | Ex. 6 | Ex. 7 | Ex. 8 |
| Application | Gloss(60°)¹⁾ | ⊚ | ⊚ | ⊚ | ◯ | ◯ | Δ |
| of primer | Adhesion²⁾ | ◯ | ◯ | ◯ | ◯ | ◯ | ◯ |
| coat | Corrosion resistance³⁾ | ⊚ | ⊚ | ⊚ | ◯ | Δ | X |
| | Gloss(20°)⁴⁾ | ◯ | ◯ | ◯ | ◯ | X | X |
| Aplication | Bending properties⁵⁾ | ◯ | ◯ | ◯ | ◯ | ◯ | X |
| of top coat | Adhesion⁶⁾ | ◯ | ◯ | X | ◯ | X | ◯ |
| (base + clear) | Corrosion resistance⁷⁾ | ◯ | ◯ | ⊚ | ◯ | Δ | X |
| | Chipping resistance⁸⁾ | ⊚ | ⊚ | ◯ | Δ | X | X |
| | CF(horizontal/vertical)⁹⁾ | ⊚ | ⊚ | ◯ | ◯ | Δ | X |

1) Gloss after application of the primer coat: The gloss was measured at an angle of 60° using a BYK haze gloss meter. The evaluation of gloss was carried out according to the following criteria: ⊚: gloss of 75 or more or less than 80; O: gloss of 70 or more to less than 75; Δ: gloss of less than 70.

2) Adhesion: The coating film was cross-cut with a knife at 1-mm intervals to form 10 cut lines lengthwise and widthwise and evaluated using Nichiban tape (O: fragment is separated from the intersection of the cut lines; x: fragment is not separated from the intersection of the cut lines).

3) Corrosion resistance: The surface of a sample having a size of 10×20 cm was X-cut at 1-mm intervals until the surface of the base material was exposed. Then, the sample was allowed to stand in a salt spray tester (SST, 35° C., 5% salt) for 72 hours, and the degree of corrosion at the X-cut portion was evaluated. Also, the adhesion of the coating film surface to the base material was evaluated using Nichiban tape at the X-cut portion (O: fragment smaller than 1 mm is separated from the X-cut portion; x: fragment larger than 1 mm is separated from the X-cut portion).

4) Gloss after application of top coat: The gloss was measured at an angle of 20° using a BYK haze gloss meter. The evaluation of gloss was carried out according to the following criteria: O: gloss of more than 90; x: gloss of less than 90.

5) Bending properties: The bending strength and strain pattern of the test sample were evaluated using a conical bending tester. When the sample was bent, compressive strain and tensile strain simultaneously occurred, and thus whether the coating film of the sample was cracked was determined. O: cracked; x: not cracked.

6) Adhesion: It was evaluated 24 hours after drying of the sample. The coating film was cross-cut with a knife at 2-mm intervals to form 5 cut lines lengthwise and widthwise and evaluated using Nichiban tape (O: fragment is separated from the intersection of the cut lines; x: fragment is not separated from the intersection of the cut lines).

7) Corrosion resistance: The surface of a sample having a size of 10×20 cm was X-cut at 1-mm intervals until the surface of the base material was exposed. Then, the sample was allowed to stand in a salt spray tester (SST, 35° C., 5% salt) for 240 hours, and the degree of corrosion at the X-cut portion was evaluated. Also, the adhesion of the coating film surface to the base material was evaluated.

8) Chipping resistance: The coated sample was allowed to stand in a cold chamber at −30±2° C. for 3 hours, and then the surface of the sample was applied with a load of size 7 (Japanese Industrial Standard) macadam (weight of stone: 50 g) by gravelometer (Suga) at a pressure of 4±0.55 bar. Herein, the temperature of the sample was maintained at −30±2° C. The evaluation of chipping resistance was carried out according to chip marks on the sample surface, and the evaluation results were rated according to the following criteria:
⊚: the diameter of a chip that penetrated into the primer coat and the base material is less than 1-2 mm.
Δ: the diameter of a chip that penetrated into the primer coat is 2-3 mm, and the diameter of a chip that penetrated into the base material is less than 1-2 mm.
x: the diameter of a chip that penetrated into the primer coat and the base material is more than 2-3 mm.

9) CF (horizontal/vertical): A base coat sample (polyester/melamine type black pearl; thickness: 10-15 μm) and a clear top coat sample (acryl/melamine type; thickness: 40-50 μm) were prepared using an ESTA Bell system (Durr). Then, the CF value that is an index of evaluation of the top coat appearance was measured using Wave-scan/DOI (BYK-Gardner). The measurement results were rated according to the following criteria:
⊚: CF value is 70 or more at the horizontal plane and 60 or more at the vertical plane;
O: CF value is 65 or more at the horizontal plane and 60 or more at the vertical plane;
Δ: CF value is 60 or more at the horizontal plane and 55 or more at the vertical plane.

As can be seen in Table 5 above, in Examples 2 and 3, the physical properties including adhesion and corrosion resistance after application of the primer and top coats were all good. However, in Comparative Example 5 in which the anticorrosive pigment was used in an amount larger than the upper limit of the range specified in the present invention and also in which the carbon nanotubes were used in an amount smaller than the lower limit of the range specified in the present invention, weldability was very poor, and chipping resistance and physical properties and workability after application of the primer and top coats were poor. Also, in Comparative Example 6, the carbon nanotubes had the effect of improving weldability, but they limited the contents of zinc dust and aluminum powder, and thus had no great effect on the increase in weldability, and corrosion resistance was reduced. In Comparative Examples 7 and 8 in which the anti-corrosive pigment was used in an amount smaller than the lower limit of the range specified in the present invention and also in which the conductive metal pigments zinc dust and aluminum powder were used in amounts larger than the upper limits of the ranges specified in the present invention, weldability was improved and these conductive metal pigments had an insignificant effect on the increase in corrosion resistance and were considered to act as factors impairing the physical properties and appearance of the coating film after application of the primer and top coats. Thus, it can be seen that, when primer/top coats are applied after the pre-primed coating composition has been applied, the physical properties of the dried coating film change depending on the contents of zinc dust, aluminum powder, anticorrosive pigment, and carbon nanotubes. In addition, it can be seen that, as the contents of zinc dust and aluminum powder increase, weldability and corrosion resistance are improved, but chipping resistance or appearance are adversely affected, because the surface of the coating film becomes rough and brittle after application of the primer/top coats.

As described above, according to the present invention, the pre-primed coating composition is prepared to contain binder resins, a crosslinker, an anticorrosive pigment, zinc dust and aluminum powder as conductive metal powders, and carbon nanotubes. Thus, the weldable pre-primed coating composition of the present invention has good storage stability, exhibits the corrosion resistance and coating adhesion comparable to those attainable by an existing electrodeposition coating process and, at the same time, shows excellent weldability. Accordingly, the coating composition of the present invention makes it possible to eliminate an existing electrodeposition coating process, and thus can contribute to an increase in productivity, an improvement in a work environment, a reduction in energy and a reduction in process time.

As described above, the weldable pre-primed coating composition of the present invention, comprising binder resins, a crosslinker, an anti-corrosive pigment, zinc dust and aluminum powder as conductive metal powders, carbon nanotubes, etc., can be applied to a metal sheet before processing of the metal sheet to maximize the weldability, adhesion, corrosion resistance and processability of the metal sheet. Also, the coating composition of the present invention can be applied to a metal sheet by a roll coating process to make it possible to eliminate not only an existing electrodeposition process which is carried out by a non-environmentally-friendly wet dipping process, but also an electrostatic spray primer coating process which is carried out by an electrostatic spray coating process in which a solvent is scattered, whereby the metal sheet coated with the pre-primed coating composition of the present invention has very excellent formability and weldability after its processing. Accordingly, it is expected that the pre-primed coating composition will greatly contribute to an increase in productivity, a reduction in energy and an improvement in a work environment owing to a reduction in the number of complex automotive coating processes.

What is claimed is:

1. A weldable pre-primed composition comprising: 20-30 parts by weight of polyester polyol and 2-5 parts by weight of epoxy resin as binder resins; 4-10 parts by weight of melamine resin as a crosslinker; 5-10 parts by weight of strontium chromate as an anti-corrosive pigment; 10-20 parts by weight of zinc (Zn) dust and 10-20 parts by weight of aluminum powder as conductive metal powders; 10-20 parts by weight of carbon nanotubes, 5-15 parts by weight of a solvent; and 1.0-3.0 parts by weight of additives.

2. The weldable pre-primed composition of claim 1, wherein the polyester polyol preferably has a weight-average molecular weight (Mw) of 4500-8500.

3. The weldable pre-primed composition of claim 1, wherein the polyester polyol is an elastomeric polyester polyol having a hydroxyl (OH) value of 20-40 mg KOH/g.

4. The weldable pre-primed composition of claim 1, wherein the epoxy resin is one or more selected from the group consisting of glycidylether type epoxy resins, glycidylamine type epoxy resins, alicyclic epoxy resins, glycidyl ester resins, heterocyclic epoxy resins, and urethane-modified epoxy resins, wherein the glycidylether type epoxy resins include bisphenol A type, bisphenol F type, brominated bisphenol A type, hydrogenated bisphenol A type, bisphenol S type, bisphenol AF type, biphenyl type, naphthalene type, fluorene type, phenol novolac type, cresol novolac type, DPP novolac type, trifunctional type, tris(hydroxyphenyl)methane type, and tetraphenylolethane type epoxy resins, and the glycidylamine type epoxy resin include tetraglycidyldiaminodiphenylmethane, triglycidyl isocyanurate, hydantoin type, 1,3-bis(N,N-diglycidylaminomethyl)cyclohexane, aminophenol type, aniline type, and toluidine type epoxy resins.

5. The weldable pre-primed composition of claim 1, wherein the melamine resin is one or more selected from the group consisting of alkyletherified melamine resins, such as hexamethoxymethylmelamine resin, butoxymelamine resin and methylolated melamine resin.

6. The weldable pre-primed composition of claim 1, wherein the pre-primed coating composition additionally comprises 0.5-2.0 parts by weight of block isocyanate as a crosslinker.

7. The weldable pre-primed composition of claim 1, wherein the zinc dust is amorphous zinc dust having a mean particle size of 3-5 μm.

8. The weldable pre-primed composition of claim 1, wherein the aluminum powder is spherical aluminum powder having a mean particle size of 3-6 μm.

9. The weldable pre-primed composition of claim 1, wherein the carbon nanotubes are multiwalled carbon nanotubes.

10. The weldable pre-primed composition of claim 1, wherein the solvent is an alcoholic solvent as one or more selected from the group consisting of methyl alcohol, ethyl alcohol, isopropyl alcohol, and n-butyl alcohol, an aromatic solvent as one or more selected from the group consisting of toluene and xylene, or a mixture of the alcoholic solvent and the aromatic solvent.

11. A method of coating a steel sheet with a weldable pre-primed coating composition comprises:
a pretreatment step (S1) of degreasing the steel sheet and pretreating the degreased steel sheet with phosphate;
a coating step (S2) of coating the steel sheet of step (S1) with a pre-primed coating composition by a roll coater to form a coating film having a thickness of 8-10 an on a dry basis; and
a drying step (S3) of baking the coated steel sheet of step (S2) in a high-temperature oven at a peak metal temperature between 200° C. and 210° C., and then cooling the baked steel sheet in air at room temperature to cure the coating film.

12. The method of claim 11, wherein the steel sheet is a galvannealed (GA) steel sheet or a hot-dipped galvanized (GI) steel sheet, or electro-galvanized (EGI) steel sheet.
